(19) United States
(12) Patent Application Publication
(10) Pub. No.: US 2005/0102063 A1
(43) Pub. Date: May 12, 2005

(54) 3D point locator system

(76) Inventor: Pierre Bierre, Pleasanton, CA (US)

Correspondence Address: Pierre Bierre, 980 Riesling Dr., Pleasanton, CA, 94566-7220, US

(21) Appl. No.: 10/987,802

(22) Filed: Nov. 11, 2004

Related U.S. Application Data
(60) Provisional application No. 60/519,411, filed on Nov. 12, 2003.

(51) Int. Cl. G06F 19/00; G05B 19/04; G05B 19/418

(52) U.S. Cl. 700/247; 700/245

(57) ABSTRACT

An automated system and method of geometric 3D point location. The invention teaches a system design for translating a CAD model into real spatial locations at a construction site, interior environment, or other workspace. Specified points are materialized by intersecting two visible pencil light beams there, each beam under the control of its own robotic ray-steering beam source. Practicability requires each beam source to know its precise location and rotational orientation in the CAD-based coordinate system. As an enabling sub-invention, therefore, an automated system and method for self-location and self-orientation of a polar-angle-sensing device is specified, based on its observation of three (3) known reference points. Two such devices, under the control of a handheld unit downloaded with the CAD model or pointlist, are sufficient to orchestrate the arbitrary point location of the invention, by the following method: Three CAD-specified reference points are optically defined by emplacing a spot retroreflector at each. The user then situates the two beam source devices at unspecified locations and orientations. The user then trains each beam source on each reference point, enabling the beam source to compute its location and orientation, using the algorithm of the sub-invention. The user then may select a CAD-specified design point using the handheld controller, and in response, the handheld instructs the two beam sources to radiate toward the currently selected point P. Each beam source independently transforms P into a direction vector from self, applies a 3×3 matrix rotator that corrects for its arbitrary rotational orientation, and instructs its robotics to assume the resultant beam direction. In consummation of the inventive thread, the pair of light beams form an intersection at the specified point P, giving the worker visual cues to precisely position materials there. This design posits significant ease-of-use advantages over construction point location using a single-beam total station. The invention locates the point effortlessly and with dispatch compared to the total station method of iterative manual search maneuvering a prism into place. Speed enables building features on top of point location, such as metered plumb and edge traversal, and graphical point selection. The invention eliminates the need for a receiving device to occupy space at the specified point, leaving it free to be occupied by building materials. The invention's beam intersection creates a pattern of instantaneous visual feedback signifying correct emplacement of such building materials. Unlike surveying instruments, the invention's freedom to situate its two ray-steering devices at arbitrary locations and orientations, and its reliance instead on the staking of 3 reference points, eliminates the need for specialized surveying skill to set up and operate the system, widening access to builders, engineers, and craftspeople.

### CROSS-REFERENCE TO RELATED APPLICATIONS

This application is filed pursuant to U.S. Provisional Patent Application 60/519,411 filed Nov. 12, 2003.

### STATEMENT REGARDING FEDERALLY SPONSORED RESEARCH OR DEVELOPMENT

None of the inventive work being applied for herein was sponsored by the U.S. Government.

### RELATED ART

U.S. Class/Subclass searched
33/1G Geometrical Instruments/Layout
U.S. Pat. No. 6,505,406
20020014015
U.S. Pat. No. 6,415,518

33/1CC Geometrical Instruments/Remote Point Locating
U.S. Pat. No. 6,437,708

33/1T Geometrical Instruments/Theodolite, Optical Readout
U.S. Pat. No. 5,091,869
U.S. Pat. No. 5,007,175
U.S. Pat. No. 4,988,192

356/3.1 Optics/Triangular Ranging to a Point w/2 or More Projected Beams
(this subclass is about location sensing technologies—Claim 2 should be cross-referenced to this class)

701/216 Data Processing—Vehicles, Navigation, and Relative Location/Having a Self-Contained Position Computing
(this subclass is about location sensing technologies—Claim 2 should be cross-referenced to this class)
   U.S. Patent Database Keyword Search

“point location” 153 patents, none relevant

“beam intersection” 15 patents, none relevant

“self location” 4 patents, none relevant

“self orientation” 11 patents, none relevant

Literature Searched

Professional Surveyor Magazine Keyword Search

“beam intersection” 8 hits, none relevant

Additional Related Prior Art

CAD-based 3D Laser Scanning (Cyra Technologies)

| | |
|---|---|
| 5,988,862 Kacyra et al. | 703/6 |
| 6,330,523 | 702/159 |
| 6,473,079 | 345/419 |
| 6,512,993 | 702/159 |
| 6,619,406 | 172/4.5 |
| 6,781,683 | 356/4.01; 356/608; 702/167 |

CAD-based Traversing Laser Locating System (Boeing)

| | |
|---|---|
| 6,480,271 Cloud, et al. | 356/152.1 |

Fan-spread-beam sweep 3D position-sensing (STS, Arc Second)

| | |
|---|---|
| 5,100,229 Lundberg, et al. | 172/4 |
| 5,110,202 Dornbush et al. | 356/3.12 |

### FIELD OF THE INVENTION

The invention relates to the field of Cartesian laser metrology, and its application in construction surveying and measuring, precision mechanical placement/alignment, and workspace layout. It generally addresses the problem of translating a 3D CAD model into real spatial locations at a construction site, interior environment, or other workspace. A significant subproblem addressed is automatically situating a metrology device in a CAD coordinate system. It should be comprehensible to one skilled in the arts of computational 3D geometry, opto-robotic instrumentation and surveying.

### BACKGROUND OF THE INVENTION

Computer-aided design (CAD) software tools have been widely adopted for designing buildings, homes, factories, interior spaces, and outdoor environments. The integration of CAD design into the building process can be characterized by three sequential stages. 1) Site modeling consists of acquiring a 3D data model of the candidate terrain or environment, and is accomplished by data collection using surveying instruments such as the total station, and 3D laser scanner. 2) CAD design creates an abstract, detailed model of the new entity to be constructed, integrated with the site model. 3) Construction proceeds as the detailed plans vested in the CAD design model are translated into reality at the site. The invention primarily pertains to this last phase (although aspects of it can be applied to the first phase).

A key problem during construction is to emplace the elements of the structure (foundation, walls, floors, ceilings, doors, windows, staircases) precisely as specified in the design. Construction techniques such as reinforced concrete and pre-formed structural members are highly unforgiving of positioning errors. The process of translating the locations called out in plans into actual physical locations for a structure such as a house typically requires manually pulling well over a thousand tape measurements. Commercial buildings require many times more measurements. Several opportunities for human error arise going from blueprint-specified distances to measuring and marking locations by tape measure. A recurring problem in the building trades is the inevitability of human error when carrying out thousands of such manual measurements.

A more reliable, error-free means of structural point location appeals to the concept of interfacing the CAD software directly to instrumentation at the site that can pinpoint locations. Initial progress has been made toward this end by interfacing a surveying instrument called the total station to CAD-output files. The total station must first be set up at a known reference location and orientation by a surveyor. Once set up, the total station can pinpoint a location in 3D space by an iterative process. A rodman standing near the specified point holds a pole upon which are mounted a reflecting prism and a display/keypad unit. Servo motors in the total station lock its IR laser beam onto the prism, and track with its movement. The target point specified in CAD is expressed in total-station-based polar coordinates (beam direction and distance). Direction is sensed from the instrument's robotic motor encoders, and distance sensed using beam-reflection range finding. Several seconds of delay are entailed in obtaining maximum accuracy from the range finder. The rodman iteratively moves the prism toward the CAD-specified point while receiving corrective signals from the display. This iterative technique detracts from the ideal of instantaneous location of a point. Furthermore, precise emplacement of building materials at the specified point is impossible since the point must be occupied by a prism.

For these reasons, as well as the expense of the total station and the specialized skill needed to operate it, such automated point location capability has so far mostly benefited large civil engineering and commercial projects. In the realm of small commercial and residential construction, the use of surveying equipment is generally limited to staking out 4 corners of a bounding rectangle, which then are outfitted with taut stringlines. The small, independent builder and carpenter is still working from blueprints and tape measurements pulled from these stringlines, with help from plumb lines, and more recently, laser level and laser square devices. None of these devices are interfaced with CAD models of the structure to be built, and accordingly, their use depends on manual translation of a blueprint.

Considering that the total station is a general surveying instrument (evolved from the transit and the theodolite) for both gathering coordinates from an arbitrary location (data collection), as well as materializing a point at specified coordinates (point location), it makes sense that specialization might allow for a less complex, easier-to-use instrument system optimized just for construction point location. Such is the thinking behind the current invention.

High-resolution GPS receivers have also been CAD-interfaced for construction surveying. Generally, the same disadvantages apply, namely iterative point-finding and point-occupancy by receiver hardware. As further limitations, GPS is only accurate to a few centimeters, i.e., well beyond building design tolerances (except for very large structures), and suffers from radio wave path perturbation error when used indoors.

Indoor positioning systems based on a periodic sweeping fan-beam have been CAD interfaced, requiring iterative point-finding and point occupancy by receiver hardware. Another laser system developed for CAD-assisted aircraft assembly embodies beam-thrower self-location, but requires expensive interferometry hardware to accomplish it.

There remains an unmet need for a CAD-interfaced, automated, 3D point locator system, which is less expensive than a total station, which can be set up and operated without specialized surveying knowledge, which is uniquely optimized ergonomically for use by a construction worker who needs both hands free to manipulate building materials into position, which gives instantaneous feedback as to when the materials are correctly positioned, and which offers spatial precision concomitant with design tolerances. The solution to this problem better forges a direct link between design and implementation in the building trades (as CAD/CAM did for manufactured parts in the 1980s), and will show itself to be economical through labor savings and prevention of costly construction errors.

### SUMMARY OF THE INVENTION

Beam Intersection. An arbitrary 3D point P=[x y z] may be pinpointed visually by making two pencil light beams intersect at P. While a reflective haze of smoke would be required to see the “X” formed where the beams intersect, as a practical matter, placement of any solid object in the path of both beams near their intersection will cause two spots of light to appear. As the reflecting object is manipulated in the direction of the intersection point, the distance between the spots decreases. The two spots smoothly converge into a single spot when the object is located precisely at the beam intersection. In this manner, the intersection of two visible light beams creates a pattern of visual feedback enabling a worker to precisely manipulate materials into position at the specified point, and to verify correctness of placement after fastening the materials in place.

CAD Design-Driven. The technique of crisscrossing beams to illuminate a precise location in 3D space becomes potent when interfaced to a CAD design. FIG. 1 illustrates an example of locating a stake that anchors a reinforced-concrete form, using visual cues obtained from beam intersection. A set of anchor stakes can be similarly located to build a concrete form enclosing any arbitrary shape the designer cares to create in CAD software. That is, the CAD software can be made to output a stakeout list of [x y z] points, and this list downloaded into the point locator instrument system. Under the worker's control, the system can then be made to visit the sequence of stake locations.

Instrument Hardware. The favored embodiment comprises a handheld control unit, two (2) identical robotic beam throwers, and three (3) reference point reflectors. FIG. 2 illustrates the system hardware components. A beam thrower comprises an instrument box which may be tripod mounted, and whose function is to steer its beam in a specified 3D direction. As shown in FIG. 3, beam steerage is robotically controlled along two polar-coordinate axes, azimuth φ and elevation θ. Azimuth control is specified to be full-range (0 to 360 degrees), while elevation may operate over a reduced range owing to mechanical constraints. The beam origin (point from which all beam rays emanate) operationally defines the location of the beam thrower. Three spot retroreflectors optically define three known reference locations.

Two-Robot Synergy. Inasmuch as the two beam throwers are identical units, it will suffice to disclose the design details of a single beam thrower. When two beam throwers are set up and operating to crisscross beams at a specified point, their apparent cooperation in doing so is illusory. Neither box is aware of the other. It suffices for each box to know its own location and orientation, and respond to an identical command (received from the handheld unit) to direct its beam toward point P.

Self-Location and Self-Orientation. The precondition for the beam thrower to be able to radiate toward point P is that it must know its precise location and rotational-orientation in the site coordinate system. Beam thrower placements are not preordained, but rather may be set up at arbitrary positions for ease-of-use. A key technical advance of the invention is that the beam-positioning instrument self-locates and self-orients in the site coordinate system, based on optical interaction with three reference points. Once the beam thrower has figured out where it is located, and how it is rotationally-oriented with respect to the site coordinate axes (to a level of precision expected in surveying instruments), it is straightforward to transform the command to radiate toward point P into the appropriate azimuth and elevation motor angles that give the desired result. The transformation is accomplished using 3D direction vector processing. Self-location and self-orientation substantially contribute toward system ease-of-use, and mitigate the setup burden of a two-instrument design.

Three Reference Points. Before deploying beam throwers, the site coordinate system must be well defined both abstractly in the CAD model, and physically at the site, and the two must agree. This is accomplished by having the designer nominate three (3) reference points forming a triangle approximately spanning the extent of the structure. The coordinate locations of the three reference points are downloaded into the handheld unit simultaneously with the rest of the CAD design. At the site, three optical spot reflectors are manually emplaced corresponding to the reference point definitions. These reference points must be located with typical surveying accuracy. The choice of reference points is arbitrary, but by convention should be chosen to effect the easiest, most dependable measurement and emplacement of reference points, for example:

| | | |
|---|---|---|
| Ref. Pt. 0: | site origin | [ 0 0 0 ] |
| Ref. Pt. 1: | 80′ out on positive x-axis | [ 80 0 0 ] |
| Ref. Pt. 2: | 60′ out on positive y-axis | [ 0 60 0 ] |

The technique used to measure and emplace the reference points is left to the discretion of the user of the invention.

Freedom of Instrument Placement

Freedom of Location. With the reference point spot reflectors in place, the beam throwers may be deployed at convenient locations within the reference point triangle. The main consideration in placing beam throwers is to achieve unobstructed line-of-sight to the design points, and to avoid degenerate beam intersections (beams nearly parallel when aimed at a design point). Placement in the plane of the reference point triangle is ill-conditioned for self-location, and must be avoided.

Freedom of Orientation. The beam thrower need not be physically aligned to site coordinate axes, i.e. there is no requirement for leveling or azimuth alignment. The tripod-mounted box can be set on unlevel ground and the azimuth home angle of the beam can be random. The only limitation on instrument tilt arises from the elevation motor axis not covering full-range (<180 degrees). For ease-of-use, the beam thrower is designed to self-orient by software computation derived from the three reference points. Once it has determined its location in site coordinates, it calculates a 3D rotator (3×3 matrix) that permits translating between directions in the site coordinate system and the beam thrower's local direction space as defined by its [φ, θ] motor axes.

Trained on Reference Points. After the beam throwers are deployed, they are trained on the three reference points. In order to train the two beam throwers on Ref. Pt. 1, the worker drags both beams into the vicinity of Ref. Pt. 1, using a handheld beam-direction-tracking sensor. Once the beam impinges on it, the sensor transmits feedback signals to the beam thrower updating its direction to remain pointed at the sensor. Once suitably close to the reference point, the beam thrower senses the strong reflection of its beam from the spot retroreflector mounted at Ref. Pt. 1, and locks onto the direction. As a convenience, both beams may be simultaneously dragged to, and trained on Ref. Pt. 1. The other two reference points are trained on in the same manner sequentially.

Motor Angles Captured. When locked onto each reference point, the beam thrower collects the motor angle data needed to self-locate and self-orient. At each point, the [φ, θ] motor angle pair is captured, accurate to about 8 μrad.

Self-Location Algorithm. The beam thrower proceeds to calculate its location in site coordinates. Using a distance triangulation method, the distances to the three known reference points yield two hypothetical locations, one of which is ruled out as inconsistent with the observed motor angle assemblage.

Tetrahedron Solves for Distances. The observed [φ, θ] angles when pointing toward the reference points are in local coordinates. The reference point locations given in site coordinates are not directly relatable. However, the distances between reference points are useful, since distances are preserved under the unknown linear transform (rotation×translation) bridging the two coordinate systems. The self-location problem reduces to solving a tetrahedron in instrument local coordinates, using the following approach. The beam origin defines [0 0 0], the only known apex of the tetrahedron. The three legs of the tetrahedron emanate outward toward the three reference points along known directions, but have unknown lengths. The opposite face of the tetrahedron (the reference point triangle) has known edge lengths. The solution entails fitting the known triangle shape into the triangular cone emanating from the origin. Using non-linear methods, a binary search algorithm solves for the three unknown leg lengths of the tetrahedron. These leg lengths signify distances from the beam thrower to the three reference points, accurate to within a fraction of a millimeter (in a 100 ft. radius workspace). Using a distance triangulation method, the location of the beam thrower is obtained with corresponding sub-millimeter accuracy.

Self-Orientation Algorithm. After figuring out its location, and knowing the locations of the three reference points, three direction vectors (in site coordinates) are constructed pointing from the beam thrower to the three reference points. Only two such direction vectors are needed. An ordered pair of direction vectors defines a direction wedge. By comparing the direction wedge calculated in site coordinates to the corresponding wedge directly observed in local coordinates, a 3D rotator (3×3 matrix) is inferred. This site orientation rotator thenceforth allows the beam thrower to move easily between direction vectors expressed in local (motor axes) coordinates, and those expressed in site coordinates. Practically, this rotator liberates the user from the cumbersome task of having to physically align the instrument with external coordinate axes, and obviates the need for on-board level sensing and φ alignment.

Point Location Operation. After the beam throwers are computationally located and oriented in site coordinates, the builder interacts with the handheld unit to step through a list of design points downloaded from CAD. The handhold commands both beam throwers to radiate toward the selected point P. In response, each instrument calculates a direction vector from itself to P, then uses its site orientation rotator to convert to a local coordinate direction vector, then into a [φ, θ] motor-move command. At this, the point of inventive fruition, the robotics see to it that the beams crisscross at P.

Point Location Accuracy. At a target point 100 feet (30 meters) from the beam throwers, typical beam proximity is <1 mm, as is the proximity of each beam to the target point. Error scales up linearly with distance, thus the invention is a local point-locator system limited to functioning within a shell radius determined by the point-location error tolerance achievable at its outer edge. Thermal air gradients, vibration, and within-instrument mechanical inaccuracies also contribute to beam crossing error. Any error in placement of the three reference point reflectors will translate linearly into point-location error.

Operational Freedom. Line-of-sight beam obstruction is circumvented by relocating the beam thrower(s), and retraining. Once additional points of reference have been established on the structure or terrain using the invention's 3D point locator capability, any three (3) of these points may be promoted in status to serve as new reference points for training the instruments. For example, after the outer shell of a building is in place, the invention may be set up inside the building to locate interior walls, doors, stairways, elevator shafts, and other features. Spot retroreflectors are emplaced at the new reference points and the beam throwers are moved indoors and retrained on them. Hillside construction is facilitated by virtue of the invention's freedom in selecting reference points—the only requirement being agreement between the physical layout of the points with their specified coordinate values given to the software, accurate to within typical surveying tolerances.

Embedded Knowledge. The setup and operational procedure of the invention is purposely designed to obviate the need for surveyor training on the part of its users. Rather, the design encapsualtes the computational geometry necessary to serve a user whose only obligation is establishing three reference points on the ground. A pair of easy-to-operate, highly-automated instruments on tripods, and a companion handheld control unit downloaded with the CAD design, then provide a means of guiding the builder to precisely manipulate all key structural components into position as intended in the design.

Extendability. The core behavior of the invention invites a whole host of additional functions that take for granted 3D point location. For example, the handheld unit offers a plumb function—while the builder holds a button depressed, the beam crisscross glides upward along a perfect plumb line. The amount of offset from a design point can optionally be specified in measured increments (foot, inch, ¼ inch). As the handheld unit becomes privy to the more structural aspects of the CAD design, it is possible to let the builder make horizontal excursions from a design point along adjoining faces, curved or straight, moving the beam crisscross horizontally along the face, in metered increments. In this regard, the invention has the potential to bring more and more of the interactive CAD experience out into the field, for instance by using handheld interactive 3D model graphics to select a physical point location. The invention has the capability to support materialization of very complex 2D and 3D patterns and shapes, opening up new possibilities in architectural design, sculpture, and ornamentation. Point location is not limited to construction. It pertains to potentially any endeavor where spatial precision is a requirement of the task at hand.

The concept of operation of the invention can be summarized as follows:
point location in 3D space is accomplished by intersecting two visible light beams
a CAD software design is downloaded into a handheld unit
site coordinates axes are defined by emplacing spot reflectors at 3 reference points
two [φ, θ] robotic beam throwers are placed conveniently to shoot at design points
beam throwers are trained on the 3 reference points using a beam-dragging handheld sensor
beam throwers automatically calculate their locations and rotational orientations
user selects the next design point to be located using handheld
at each design point selected, beam throwers crisscross beams at specified point
using visual feedback, user positions construction materials to beam intersection

The seminal qualities of the invention can be summarized as follows:
the two-beam intersection concept affords superior point location resolution and speed compared to a total station instrument (single beam with range-finding)
the design embodies a new method for precise optical self-location of a polar-coordinate angle-sensing device in a rotationally-obscured frame of reference
the invention exploits redundant automata principles by synergizing two identical beam-positioning robots
by virtue of its self-locating and self-orienting capabilities, the invention redefines the partnership between surveying instrument and user, widening access to non-specialists

### BRIEF DESCRIPTION OF THE DRAWINGS

FIG. 1 Concrete Form Stake Located Using Beam Intersection

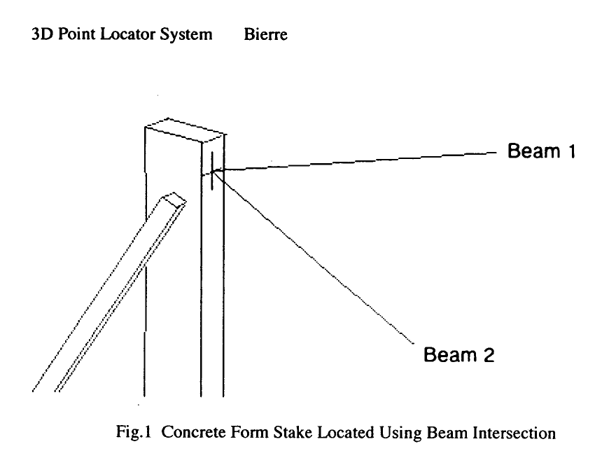

FIG. 2 System Hardware Components

FIG. 3 Beam Thrower Robotic Motion Axes

FIG. 4 Examples of Direction Vectors

FIG. 5 Example of 3D Rotation Function

FIG. 6 Tetrahedron Solves For Distances to Reference Points [r0, r1, r2]

FIG. 7 Beam Thrower's Self-Location Algorithm

FIG. 8 Search Space [r0, r1] and Elliptical Curve Generator

FIG. 9 Search Evaluation Function Δr2

FIG. 10 Extracting the Site Orientation Rotator

FIG. 11 Handheld Unit User Interface Functions

FIG. 12 Reduction to Practice in Cartesia Simulator

### DETAILED DESCRIPTION OF THE INVENTION

3D Direction Vectors and Rotators

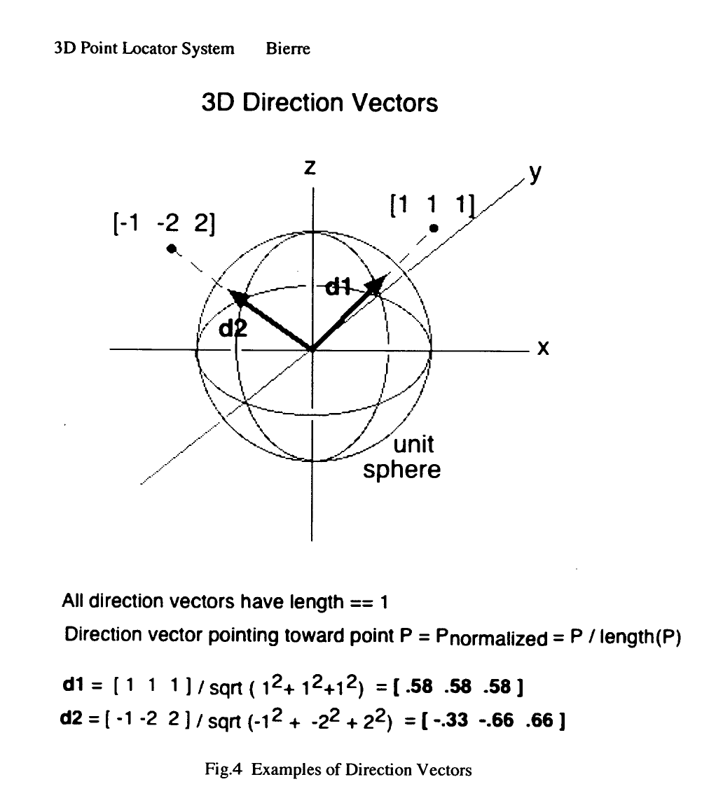

The geometric algorithms underlying the invention are based on direction vector processing. Directions in 3D space are represented as vectors of unit length, with tails at the origin, and heads on the unit sphere. FIG. 4 illustrates two distinct directions, d1 and d2, specified computationally as direction vectors.

Rotation of a 3D coordinate space about the origin can be managed in a similarly direct manner. Given that the rotation transforms points from old coordinates into new coordinates, one need only furnish the new x, y, z axes in old coordinates to specify the rotation. Each new axis is expressed as a direction vector. As a group, the new axes must maintain the same spatial relationship among each other as the basis vectors in the old space (by convention, only right-handed axes are used).

Rotating a point P into its new coordinates P′ is carried out using the matrix operation:
P′=P·(newXaxis newYaxis newZaxis)=P·R
where the column vectors of the matrix are the new positive axis directions. In the current invention, the 3×3 matrix R is referred to as a rotator. To create a unique rotator, only two axes need be specified—the third axis is totally dependent on the other two, and may be obtained from their cross product. The cross product is valuable for generating a direction vector mutually perpendicular to any two distinct directions, but requires that the result be normalized (length=1).

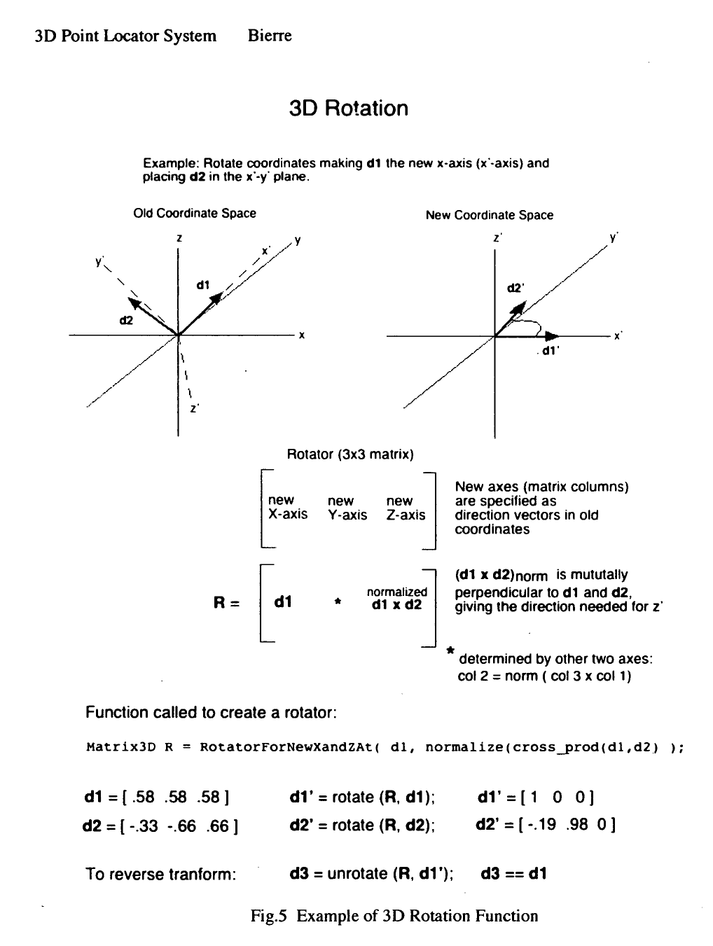

FIG. 5 graphically shows a rotational transform corresponding to the pseudocode for the rotate function. A sibling unrotate function performs the inverse rotation R⁻¹.
P′=rotate (R, p)
p=unrotate (R, P′)

Creator functions are designed to supply rotators on demand:
Matrix3D R=RotatorForNewXandZAt (newXaxis, newZaxis);

An implementation of the creator function is:

```
Matrix3D RotatorForNewXandZAt (DirVec3 newXaxis,
DirVec3 newZaxis) {
      Matrix3D rotator = new Matrix3D( );
      rotator.column1 = newXaxis;
      rotator.column2 = normalize ( cross_prod (newZaxis ,
      newXaxis ));
      rotator.column3 = newZaxis;
      return rotator;
}
```

Beam Thrower's Self-Location Algorithm

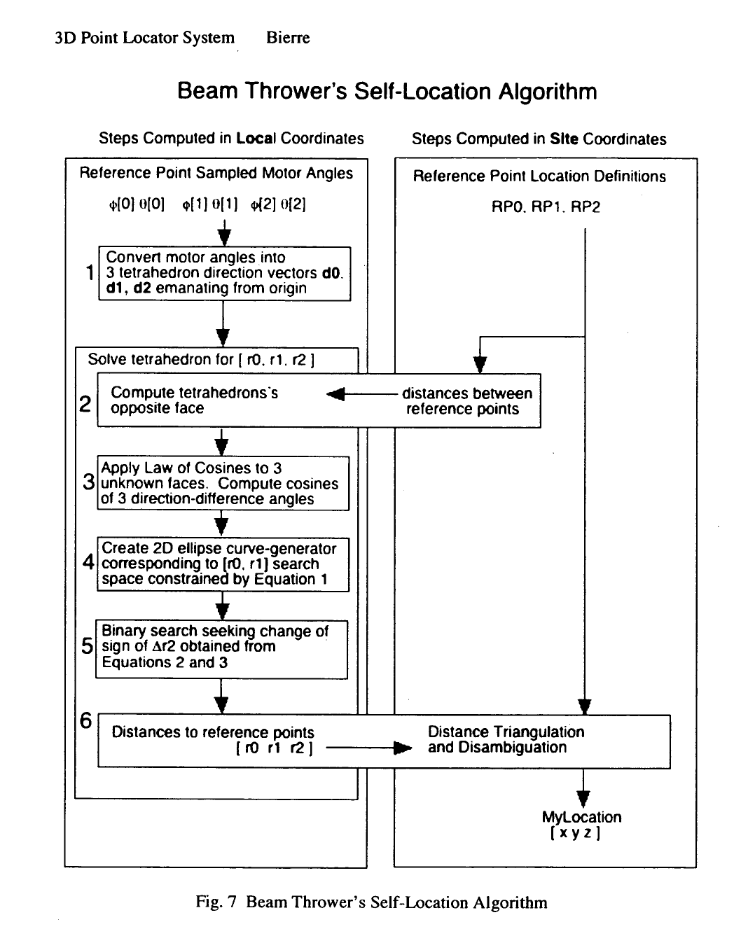

The algorithm by which the beam thrower determines its location in site coordinates is disclosed as an overall strategy and a sequence of steps. FIG. 7 is a block diagram showing the sequence of steps.

The input data provided to the algorithm from the CAD design (communicated from the handheld unit to the beam thrower) are:

| | Location |
|---|---|
| Reference Point | (in site coordinates) |
| 0 | RP0 |
| 1 | RP1 |
| 2 | RP2 |

The input data provided to the algorithm collected while sampling the 3 reference points are:

| | Motor Angles [azimuth elevation] |
|---|---|
| Reference Point | (in local coordinates) |
| 0 | [φ[0] θ[0]] |
| 1 | [φ[1] θ[1]] |
| 2 | [φ[2] θ[2]] |

Step 1. Convert Motor Angles into Local Direction Vectors

The motor angles expressed in polar coordinates [φ, θ] are converted into local coordinate direction vectors d0, d1, d2, using this general approach:

```
DirVec3 DirVec3OfPhiTheta( double φ, double θ) {
      DirVec3 d = new DirVec3 ( );
      d.x = cos(θ)*cos(φ);
      d.y = cos(θ)*sin(φ);
      d.z = sin(θ);
      return d;
```

Overall Strategy: Solve Tetrahedron

If the distances from the beam thrower to each reference point can be obtained accurately enough (<0.15 mm error), then the beam thrower can self-locate by distance triangulation with corresponding spatial accuracy.

Four points, consisting of the beam thrower's location and the three reference points, form a tetrahedron. In the beam thrower's local coordinate system, what is known about the tetrahedron is:
1) the apex at [0 0 0] (where the beam thrower is located)
2) direction vectors d0, d1, d2 pointing toward the other three apices
3) the opposite face (reference triangle) side lengths s01, s02, s12

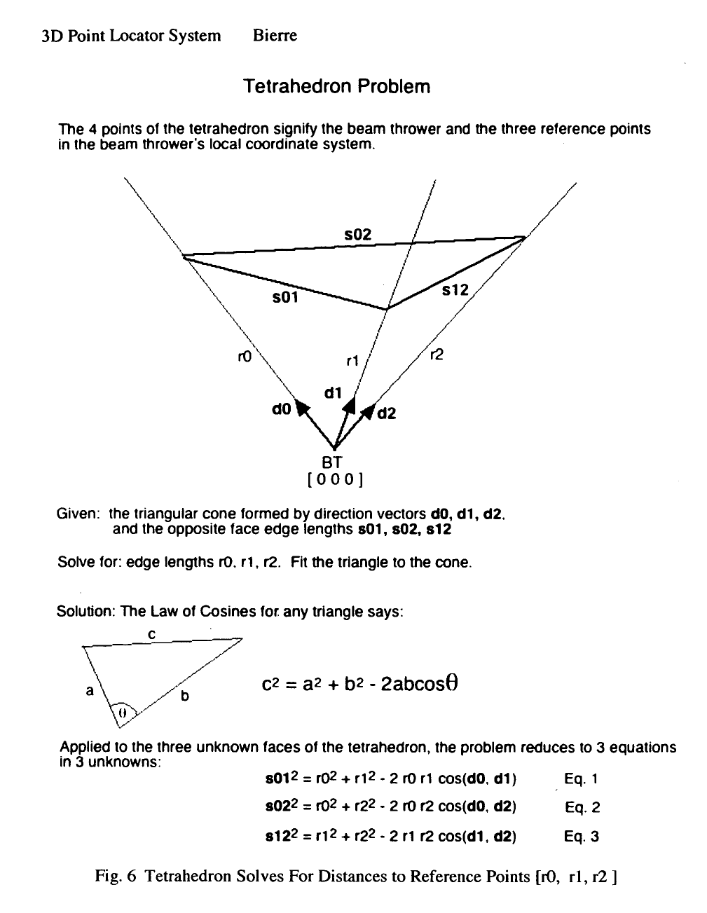

What is desired to be known about the tetrahedron are the distances from the origin to the three reference points, r0, r1, r2. FIG. 6 illustrates the tetrahedron problem that lies at the core of the self-location problem.

A strategy for solving the tetrahedron applies the Law of Cosines to each of its three unknown triangular faces:
s01²=r0²+r1²−2*r0*r1*cos(d0, d1) Eq. 1
s02²=r0²+r2²−2*r0*r2*cos(d0, d2) Eq. 2
s12²=r1²+r2²−2*r1*r2*cos(d1, d2) Eq. 3

Because of the cross-terms, the three variables [r0, r1, r2] cannot be solved using linear methods. A non-linear search is required.

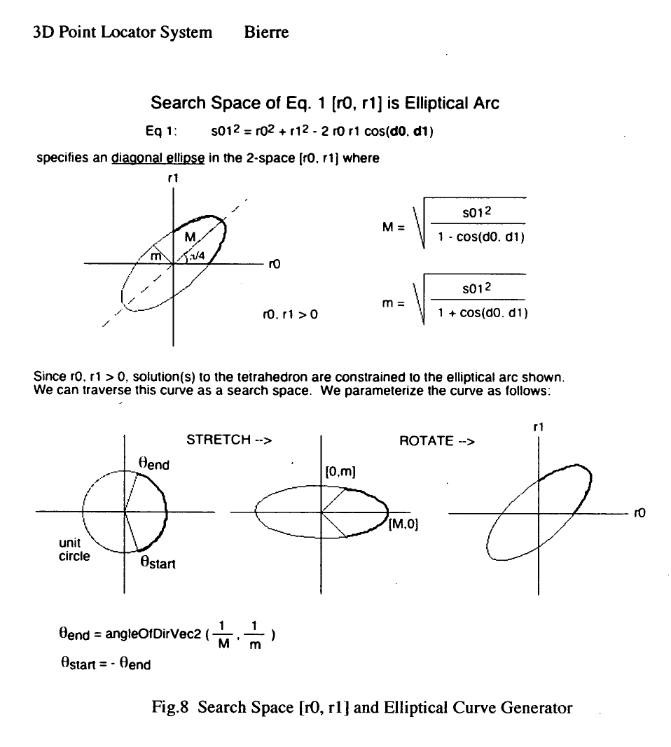

FIG. 8 illustrates the non-linear search algorithm graphically. Each equation above specifies, in the 2-space of its variables, an origin-centered, diagonal ellipse (tilted CCW 45 degrees). We search along the elliptical curve specified by the first equation, visiting candidate pairs of [r0, r1]. Since r0, r1>0 the search space reduces to the elliptical arc in the first quadrant. Each candidate [r0, r1] is substituted into the other two equations, which reduce to quadratic equations in the single variable r2. When both equations return the same value for r2, an algebraic solution [r0, r1, r2] has been found.

Multiple algebraic solutions are possible in certain cases of beam thrower placement outside the reference point triangle. As the beam thrower position grows distant from the reference triangle, an algebraic solution becomes ill-conditioned. A well-behaved, singular algebraic solution to the tetrahedron problem is ensured by specifying beam thrower tripod placement within the outline of the reference point triangle.

After solving the tetrahedron for [r0, r1, r2], self-location is computed in site coordinates by distance triangulation from the three reference points. The algorithmic strategy having been explained, we continue with the step by step process details.

Step 2. Compute Tetrahedron's Opposite Face

The triangle defined by the three reference points is useful in terms of its side lengths:
s01=distance (RP0, RP1);
s02=distance (RP0, RP2);
s12=distance (RP1, RP2);
   Step 3. Compute Cosines of Direction-Difference Angles

The cosine of the angle formed by two 3D direction vectors (difference angle) is obtainable from their dot product:
a01=dot prod (d0, d1);
a02=dot prod (d0, d2);
a12=dot prod (d1, d2);
   Step 4. Create 2D Ellipse Curve-Generator Corresponding to Equation 1

The elliptical arc search space [r0, r1] can be transited sequentially by creating a curve generator parameterized by θ on a unit circle. The ellipse is generated by first stretching the unit circle by [M, m], the major and minor half lengths of the ellipse, then rotating the ellipse CCW 45 degrees. FIG. 8 shows how the search space is parameterized using a curve generator in 2D space, based on a stretch-rotate transformation of the unit circle.

The key quantities needed for the ellipse generator are derived from Equation 1:
M=sqrt (sqr(s01)/(1−a01));
m=sqrt(sqr(s01)/(1+a01));
DirVec2 tilt=new DirVec2 (1, 1);//normalizes
θend =AngleOfDirVec2 (1/M, 1/m);
θstart=−θend;

The search range for θ is determined by the Quadrant I intercepts of the tilted ellipse, back-transformed into values on the unit circle. Points P_{search} on the ellipse are accessed using the generator:

```
for (θ=θstart; θ <= θend; θ+=Δθ) {
      Vec2 P = new Vec2 ( M * cos(θ), m * sin(θ) );
      Vec2 P_{search} = unrotate(tilt, P);
      boolean SolutionFound = TestForSolution(P_{search});
      }
```

Rotating the ellipse in 2D is accomplished using a rotational transform function that takes a newXaxis as its argument (analogous to how 3D rotation is specified). The direction vector tilt points diagonally at 45 degrees. To add rotation, the unrotate function is called.

Step 5. Binary Search Seeking Change of Sign of Δr2 Obtained from Equations 2 and 3

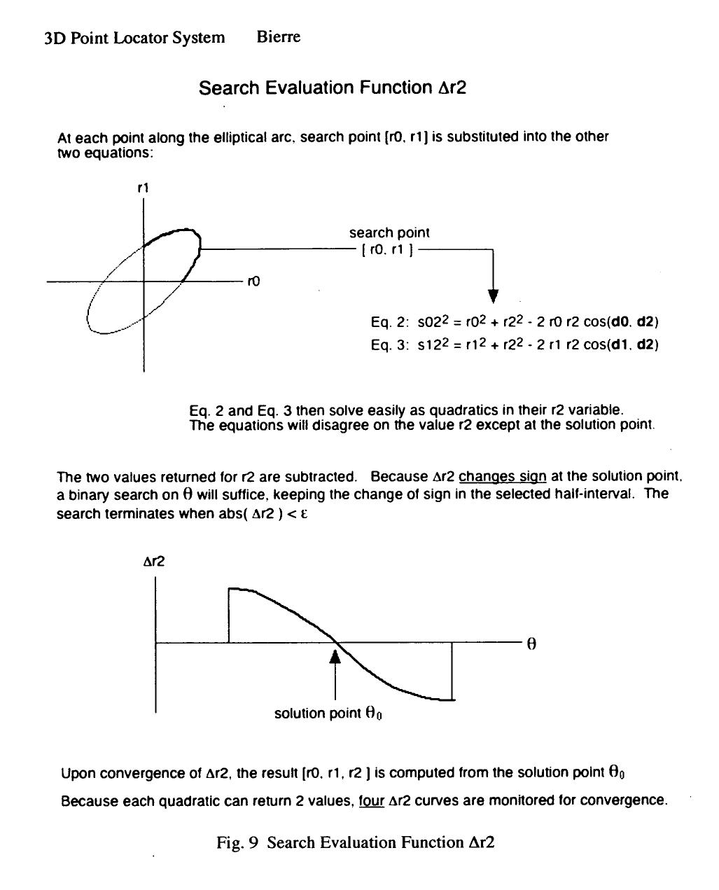

Since Equations 2 and 3 have to evaluate equally for the value of r2 at the solution point, the difference between the values of r2 obtained from the two equations Δr2 undergoes a change of sign on any search interval bracketing the solution. This makes it possible to home in on a solution using a simple binary search. FIG. 9 illustrates the evaluation function Δr2. The match criteria for the search is:

```
boolean TestForSolution(P_{search}) {
      double Δr2 = EvaluateEq2(P_{search}) − EvaluateEq3(P_{search});
      return (abs (Δr2) < ε);
      }
```

Inasmuch as Equations 2 and 3 reduce to quadratics in r2, each equation evaluation contributes the possibility of two (2) real solutions for r2. Therefore, when comparing results form the two equations, the algorithm must compare up to four possible values for Δr2. The above pseudocode suppresses this detail.

The tetrahedron solution is carried forward as the distance vector [r0, r1, r2].

Step 6. Distance Triangulation and Disambiguation

The last step of the self-location algorithm takes the precise solution for distances to the three reference points [r1, r2, r3], and the known reference point locations in site coordinates RP0, RP1, RP2, and computes location by distance triangulation. In the preferred embodiment, three spheres are constructed about the reference points

| Sphere | Center | Radius |
|---|---|---|
| 0 | RP0 | r0 |
| 1 | RP1 | r1 |
| 2 | RP2 | r2 |

and the intersection of three spheres is computed. Two possible intersection points exist, located symmetrically on either side of the reference triangle plane. Each intersection is entertained as a location hypothesis. For each hypothesis, a set of three direction vectors is constructed pointing to the three reference points (in site coordinates). For the correct location hypothesis, this direction vector assemblage will be consistent with the direction vector assemblage observed in local coordinates. Under a suitable rotation, the direction triples will overlay perfectly.

```
boolean LocationHypothesisValid (Vec3 LocationHypothesis) {
  DirVec3 d0_site = DirVec3of(LocationHypothesis, RP0); // (from, to)
  DirVec3 d1_site = DirVec3of(LocationHypothesis, RP1);
  DirVec3 d2_site = DirVec3of(LocationHypothesis, RP2);
  DirVec3 d0_local = DirVec3OfPhiTheta(φ[0], θ[0]);
  DirVec3 d1_local = DirVec3OfPhiTheta(φ[1], θ[1]);
  DirVec3 d2_local = DirVec3OfPhiTheta(φ[2], θ[2]);
```

| | |
|---|---|
| Matrix3D R = RotatorSpecifiedByIOWedges | (/*input*/ d0_local, |
| | d1_local, |
| | /*output*/ d0_site, |
| | d1_site); |

```
  boolean assemblageMatches =
      (distance(rotate(R,d1_local), d1_site) < ε) &&
      (distance(rotate(R,d2_local), d2_site) < ε);
  return assemblageMatches;
  }
```

The function RotatorSpecifiedByIOwedges( . . . ) that finds the suitable rotation is explained in the next section.

The disambiguated location result is stored as MyLocation. This concludes disclosure of the beam-thrower's self-location algorithm.

Beam Thrower's Self-Orientation Algorithm

Once the beam thrower's location is determined, direction vectors pointing to arbitrary points P in site coordinates may be computed. For example, the reference points have directions:

DirVec3 d0_site = DirVec3of(MyLocation, RP0); // (from, to)
DirVec3 d1_site = DirVec3of(MyLocation, RP1);
DirVec3 d2_site = DirVec3of(MyLocation, RP2);

where

```
DirVec3 DirVec3of(Vec3 FromPt, Vec3 ToPt)
      {
        if (Identical(FromPt,ToPt)) return null;
        return new DirVec3(normalize(ToPt - FromPt));
      }
```

For the beam thrower to be able to steer its beam correctly, it must understand how its robotic motor drives are situated rotationally with respect to the site coordinate axes. Then, it can apply the suitable rotational correction computationally before instructing its motor drives. This feature frees the invention's tripod instruments to be situated without alignment.

The self-orientation algorithm computes the beam thrower's site orientation rotator. This 3×3 matrix converts direction vectors from local->site coordinates:

dir_site = rotate ( MySiteOrientationRotator, dir_local);

When responding to the handheld unit's command to radiate toward point P, the beam thrower must transform in the opposite direction (site coords->local coords) to obtain the correct motor angles:

DirVec3 DesiredDirection = DirVec3of(MyLocation, P);
DirVec3 DesiredDir_local = unrotate(MySiteOrientationRotator,
DesiredDirection);
Vec2 DesiredMotorPhiTheta = PhiThetaAnglesOfDirVec(DesiredDir_{—}
local);

The SiteOrientationRotator is inferred by example. The rotational difference between local coordinates and site coordinates is already manifest in the two triplets of direction vectors pointing toward the reference points. A pair of direction vectors glued together are sufficient to assess the amount of rotation they have undergone. The term wedge is applied to such an ordered pair of direction vectors. Given an input wedge, and an output wedge, the rotational transformation from input to output can be inferred.

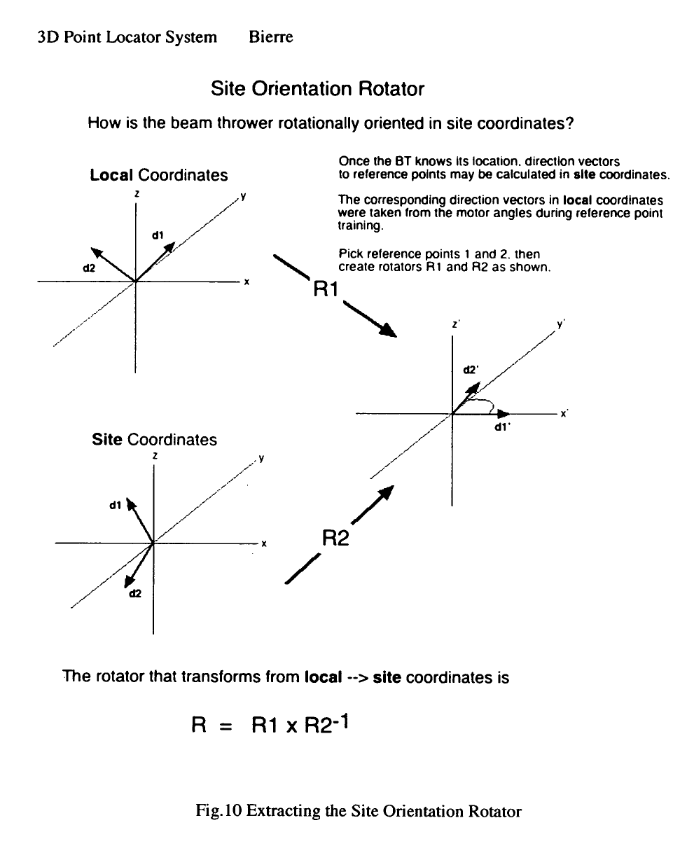

FIG. 10 illustrates graphically how the unknown rotator can be extracted from input and output wedges. The process consists of three steps. A rotator R1 is defined that rotates wedge1 into alignment with the coordinate axes. A second rotator R2 is defined that rotates wedge2 into the exact same alignment with the coordinate axes.

Think of the sought-after rotator as a plane flight that transports wedge1 to wedge2. The coordinate axes are a layover point where we change planes. We already know how to get from wedge1 to the stopover:
R1: wedge1→coord axes

We also know how to fly backwards from the destination to the stopover:
R2: wedge2→coord axes

The transformational path that solves for the rotator R is:
R1×R2⁻¹: wedge1→coord axes coord axes→wedge2

Example pseudocode for the self-orientation algorithm is:

```
MySiteOrientationRotator =
    RotatorSpecifiedByIOWedges(/* wedge1 */ d0_local, d1_local,
            /* wedge2 */ d0_site, d1_site);
```

where the key function is implemented along the lines of:

```
Matrix3D RotatorSpecifiedByIOWedges(DirVec3 Input_DirA, DirVec3 Input_DirB,
                              DirVec3 Output_DirA, DirVec3 Output_DirB) {
      Vec3 Input_CrossProdNorm = normalize(cross_prod(Input_DirA,Input_DirB));
      Vec3 Output_CrossProdNorm = normalize(cross_prod (Output_DirA,
Output_DirB));
      Matrix3D R1 = RotatorForNewXandZAt(Input_DirA, Input_CrossProdNorm);
      Matrix3D R2 = RotatorForNewXandZAt(Output_DirA, Output_CrossProdNorm);
      Matrix3D R2_inv = InvertRotator(R2);
      Matrix3D R = MatrixMult(R1, R2_inv); // composite rotation
      return R;
      }
```

The choice of the d0-d1 wedge is somewhat arbitrary. The other two pairings of direction vectors are equally valid, and a refinement is suggested whereby all possible pairings contribute toward formation of a more accurate rotator R.

This concludes the detailed disclosure of the beam thrower's self-orientation algorithm.

Beam Throwing Algorithm

Upon completion of the setup procedure, the beam thrower has the information it needs to begin casting its beam in the direction of any specified point P. The algorithm for doing so is straightforward:

```
ThrowBeamToward (Vec3 P) {
  DirVec3 DesiredDirection = DirVec3of(MyLocation, P);
  DirVec3 DesiredDir_local = unrotate(MySiteOrientationRotator,
                DesiredDirection);
  CurrentMotorAngles = PhiThetaAnglesofDirVec(DesiredDir_local);
  // send motor angles off to motor controllers
}
```

In the handheld unit, the coordination of the two beam throwers is orchestrated by merely communicating (by radio link) a command to both units:

```
ThrowBeamIntersectionAt(Vec3 P) {
      BT1.ThrowBeamToward(P);
      BT2.ThrowBeamToward(P);
      }
```

This concludes the detailed disclosure of the beam throwing algorithm.

Object Position-Sensing/Tracking/Surface Contouring Algorithm

Although optimized to work as a 3D point-locator system, the invention can be turned to the task of 3D geometric point-sensing with little embellishment (at least computationally). The sub-millimeter optical positioning accuracy of the invention posits a distinct advantage over radio wave propagation systems like GPS, which cannot resolve position so finely. Assuming a means of making the two beam throwers intersect beams at the point of interest, each beam thrower reports to a common receiver the line equation of its beam. The common receiver is left merely the task of computing the intersection of two 3D lines in order to compute the 3D coordinates of the point of interest.

In the common receiver:

```
Vec3D SenseCurrentBeamIntersection( ) {
    Line3D Beam1 = BT1. SenseCurrentBeamLineEq( );
    Line3D Beam2 = BT2. SenseCurrentBeamLineEq( );
    return IntersectionOf (Beam1, Beam2);
    }
```

In each respective beam thrower:

```
Line3D SenseCurrentBeamLineEq( ) {
    // poll motor drives for CurrentMotorAngles
    DirVec3 Dir_local =
    DirVecOfPhiThetaAngles(CurrentMotorAngles);
    DirVec3 Dir = rotate(MySiteOrientationRotator, Dir_local);
    return Line3DofDirAndPt(Dir, MyLocation); // in site coordinates
    }
```

This concludes the detailed disclosure of the object position-sensing/tracking algorithm.

In another embodiment, the 3-point automated setup algorithm taught herein is applied to a plurality of laser scanning or photogrammetric instruments as a means of assuring that the datasets they produce are already correlated, i.e. expressed in a unified coordinate system. One example of correlated data acquisition is stereoscopic metrology.

Beam Thrower Instrument Specification

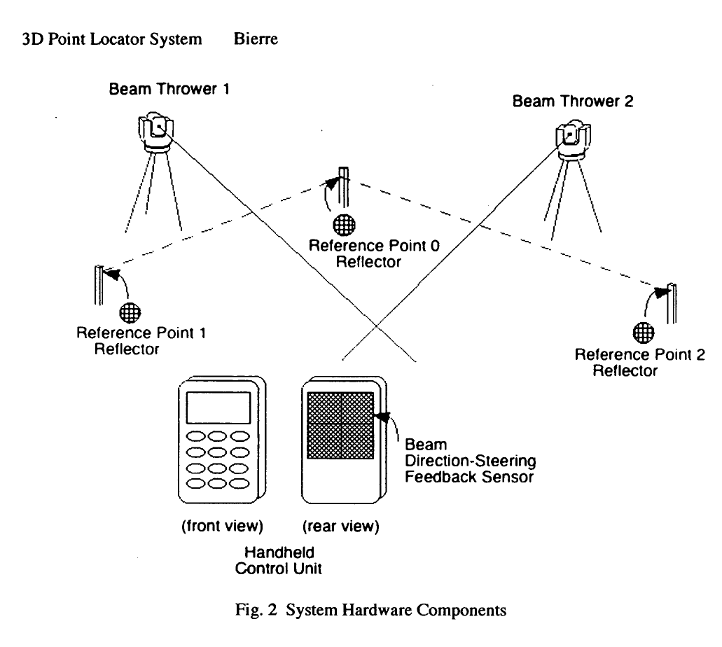

FIG. 2 illustrates the hardware components of the invention.

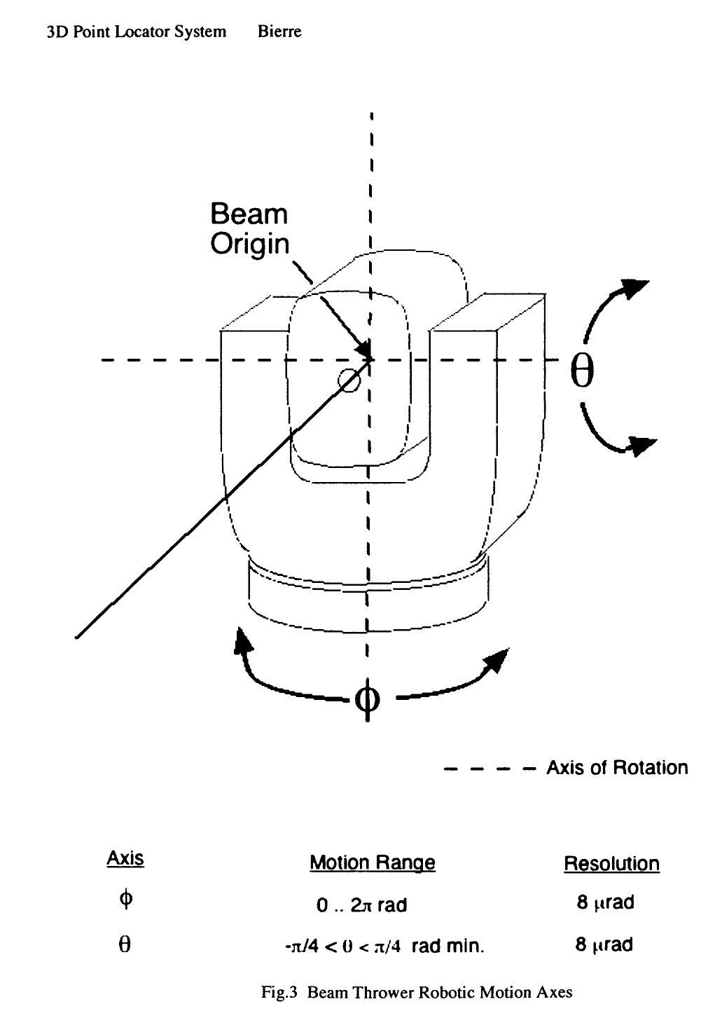

The two beam thrower instruments function identically as a slave robotic devices under the control of the handheld unit via short-range (<¼ mile) radio link. FIG. 3 specifies the robotic motion axes for steering the beam:

| Axis | Motion Range | Resolution |
|---|---|---|
| φ | 0 . . . 2π rad | 8 μrad |
| θ | −π/4 < θ < π/4 rad (min.) | 8 μrad |

The allowable backlash in motor drives shall be <4 μrad.

The beam origin is the common point through which all beam rays emanate (geometrically). It is required that the beam origin coincide with the intersection of the two axes of rotation. This point operationally defines the location of the instrument in the site coordinate system.

The φ and θ axes of rotation must be mechanically perpendicular to within 4 μrad, and the θ=0 home position must be on-perpendicular to the φ rotation axis (mechanically or by calibration). Otherwise, the registration of motor axes with the casing and tripod base may be loosely controlled, as the self-orientation algorithm compensates out such variations, an advantage pertaining to manufacturability. However, the home angle positions of the motor drives must be repeatable to within a 2 μrad standard deviation, and the drives free of accretion error.

The beam light source shall be a low-divergence (<30 μrad) laser or other source having visible wavelength. It needs to fall into the Class II CDRH safety category (<1 mW), and be capable of sharing a standalone battery power supply with other on-board electronics for 8-12 hours of operation between charging.

A photodetector sensor shall detect a retroreflection of the beam back onto its path of origin. During the tracking mode used during training on a reference reflector, the electronics and software shall support the ability to find the direction pointing to the reflector with assistance from the user. The preferred embodiment appeals to the user steering or dragging the beam to the angular vicinity of the reference point in order to reduce the extent of angular space to be searched, and to mitigate stray radiation in the outdoor environment.

The beam thrower shall contain an embedded controller and software capable of operating all specified behaviors remotely under radio-link from the handheld unit.

The beam thrower instrument shall be ruggedized for construction site survivability, be tripod-mountable, and easily portable.

Reference Point Reflector Specification

Each reference point shall have affixed to it a circular spot retroreflector approximately 0.10″ in diameter. Though not essential, a refinement is to make the spot reflector omni-directional. An example of reflective material is 3M ScotchliteVery High Gain 3000X Sheeting.

Handheld Controller Specification

The handheld unit serves as the point of coordination between the user, the CAD design, and the beam throwers. It may comprise a Pocket PC-style computer/touchscreen with radio-wave ethernet link. A holster mount furthers the objective of leaving the construction worker with two free hands.

In the preferred embodiment, the back of the handheld unit contains a beam-dragging feedback sensor allowing the worker to guide the beams into the vicinity of the reference points during training. The sensor shall detect excursion of the beam spot(s) from the center of the sensor. An internal gravity-vector sensor in the handheld, for example liquid-filled switches, shall make it possible to transform the raw 2D coordinate space of the sensor into vertically-oriented 2D coordinates. The software sends feedback signals to the beam thrower(s) correcting beam direction back toward the center of the sensor.

The CAD design is downloaded into the handheld by radio-ethernet, wire, or pluggable memory chip.

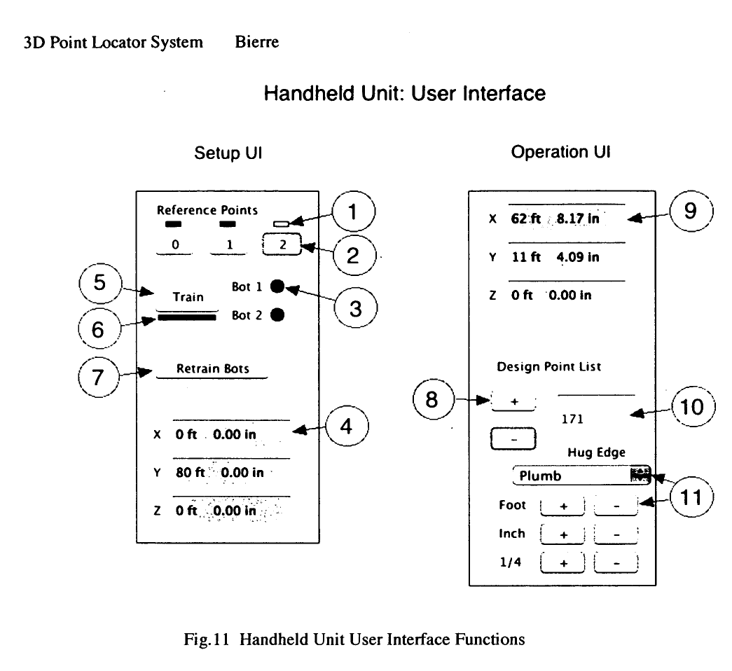

FIG. 11 illustrates by example a user interface sufficient to operate the invention. The core functions are negotiating the setup sequence, and then stepping through a list of 3D design points. An advanced feature demonstrates the use of metered plumb upward and downward from a design point. Annotated user-interface features in FIG. 11 are:
1) LED indicator gives status of reference point by color: off=point not acquired, yellow=currently searching to acquire point, green=point acquired.
2) User presses button to begin search mode on the selected reference point
3) Bot LED indicator gives status of robotic beam throwers 1 and 2: off=not ready, green=ready to locate points
4) Reference point x y z coordinate display
5) Use presses to have both beam throwers run self-location and self-orientation
6) LED indicator indicates if beam throwers are self-located and self-oriented
7) User presses to register intent to retrain beam throwers
8) User presses to step through design point list (advancing beam crisscross)
9) Currently crisscrossed design point x y z coordinate display
10) Number in design list of current design point
11) Plumb offset buttons—user presses to make metered excursion along vertical
   Reduction to Practice in Cartesia Simulator

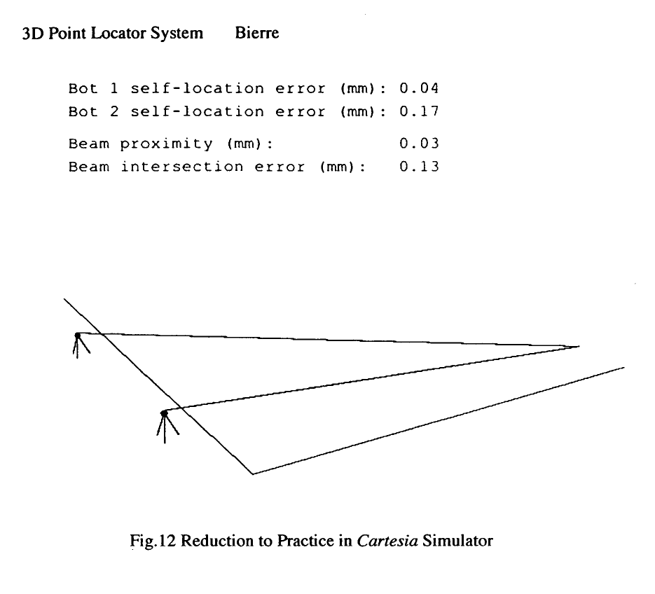

FIG. 12 is a screen capture from the invention's early reduction to practice in an interactive, 3D graphics simulator (code name: Cartesia). Key features are the beam throwers and reference point baselines, and a superimposed wireframe-rendering of a simple CAD-like design. The example demonstrates the power of a CAD-driven automated point locator system to locate points along a circular arc in 3D space, a classic problem impossible to solve with a radius cord if conditions prevent physically sweeping an arc.

Results data are displayed indicating the two beam thrower's self-location errors, and beam crossing performance data. Beam proximity is the distance between the two beams at closest approach. Beam intersection error calculates the midpoint along the closest approach line, and is its distance from the target point. All errors are sub-millimeter (<1 mm).

The simulator demonstrates the use of 3D interactive graphics as an alternative means for selecting design points to be projected. The advantage over list selection is increased immediacy, and the ability to associate any graphically-conveyable information having to do with a particular spatial location. For example a tiling pattern is able to be implemented by a mason with point-by-point tile color selection guidance, by using the handheld graphic model to step forward along a row.

Advantages of the Invention

Advantages with respect to blueprint-stringline-tape-measure point location. For the vast majority of construction workers, the invention posits a new paradigm for locating building materials in 3D space, one able to automatically pinpoint physical locations at the construction site preordained in a CAD design. The major benefits of the invention are increased efficiency and accuracy in locating points, and avoidance of human errors that are inevitably interspersed among hundreds of tape measure pulls.

The traditional method invites accretion of error because points are arrived at through a succession of tape pull measurements. Not only do measurements have to be split into separate x, y, z measurements, but for convenience sake, few measurements key directly off of the axis stringlines, but rather start from established points that already embody some measurement or building error. By contrast, the invention locates points in 3D over only one level of indirection, namely the locations of the beam throwers, which trace directly back to the coordinate axes. Therefore, the invention is aguably more accurate in locating 3D points than are techniques dependent on a sequence of manual tape-measurements.

Compared to the traditional coordinate-establishing technique of staking out local x-y axes and running taut stringlines along them, the invention's requirement for the staking of the origin and axis endpoints is functionally equivalent.

Advantages with respect to CAD-interfaced total station point location. Whereas the total station is a professional surveyor's instrument presuming considerable specialized knowledge and training, the invention is designed for use by construction teams with no particular training in surveying theory, equipment or technique.

Comparing the invention to the technique of 3D point location using a CAD-design-interfaced total station, several advantages accrue, all reflecting the objective of a point-locator system.

The invention's method of pinpointing a location by holding a stable 2-beam intersection there posits advantages over the total station's single beam+prism distance approach. Because time-of-flight distance samplings must be integrated over several seconds to achieve a distance accuracy of ⅛ inch, the object positioning feedback of the total station is inherently inferior to the instantaneous visual feedback provided by the crisscrossed beams. Instantaneous feedback lends support to interactive, CAD-on-site features such as plumb and edge excursion.

The total station technique's dependence on the worker to iteratively move a prism pole into the specified position given corrective signals displayed on a screen is slow and cumbersome compared to the invention's requirement for a single button-press on the handheld unit which then orchestrates the robotic positioning of the beam crisscross at the desired location.

The prism has the disadvantage of occupying the specified location, making it impossible to position building materials there. By contrast, the invention does not occupy any space at the specified point, rather, it exploits the presence of building materials to create the pattern of visual feedback signifying correct emplacement. In this regard, the invention is better suited to point location in construction. The pinpoint accuracy of the total station in point-location mode is limited to locating its prism, thus it is arguably less accurate than the invention for purposes of precision positioning of building materials.

Another advantage is the ease-of-use in setting up the instrumentation. The total station must be situated directly over a reference point using a plummet, and precisely-aligned visually through a telescope with a 2^{nd} reference point. This setup procedure assumes a significant degree of technical surveying skill just to operate the instrument. The beam throwing instruments of the invention require no such careful positioning and alignment, by virtue of their self-locating and self-orienting software. A non-technical procedure for training the instruments into the site coordinate system is provided. A handheld controller optimized to the task of one-person construction is provided as well. The invention represents a system design more specialized to the task of construction than does the total station, which as the name implies, is a general-purpose surveying instrument.

By eliminating telescope optics, leveling sensors, plummet, and time-of-flight (range-finding) time-modulated laser and electronics, the invention derives a cost savings over a total station (although the invention's need for two instruments increases cost). The greater savings is in avoiding the daily cost of a trained surveyor to operate equipment. In this regard, the invention offers the advantage of affordability and accessibility to a builder who has not yet enjoyed the key advantages of CAD-integrated, automated 3D point location. Those are the avoidance of construction errors that are inevitable over the course of hundreds of manual tape measurement, and the efficiency of pressing a button to locate a point vs. pulling tape measurements.

Advantages with respect to CAD-interfaced GPS point location. High resolution GPS positioning devices offer less spatial resolution (1-2″) than within-building design tolerances generally allow(1/16″-⅛″). By contrast, the invention is capable of 1-millimeter resolution. Even if GPS offered the desired resolution, for point location it still has the disadvantages of iterative human search for the specified point, and the receiver hardware's need to occupy space at the measured point.

Other Advantages. An advantage to architects is the ability to take on more complexity and design daring owing to the additional confidence that the builders can manage such complexity. With CAD-interfaced 3D point location, a new channel of communication between designer and builder is established, one with tremendous capacity for detail. For example, the invention makes practicable the materialization of arbitrarily complex 3D surfaces, having large dimensions, permitting new types of styling within crafts such as poured concrete, framing, bricklaying, roofing and tiling.

The trend toward factory prefabrication of buildings, and increased use of pre-formed structural members demands precision in laying foundations, to ensure compatibility during assembly. The invention posits a means of achieving millimeter precision on the ground for receiving structures.

As much of the world's most desirable flat land has already been developed, there is a future trend toward hillside construction. The invention's 3D point-location capability and freedom in selecting ground-based reference points makes it well adapted to hillside construction.

The angular self-location and self-orientation method from three known reference points taught by the invention signifies an advance in positioning technology. The algorithms taught are potentially applicable to other position-sensing problems.

So ubiquitous are problems involving use of CAD to specify design details needing to be carried out under eye-hand coordination, the invention signifies a broadly applicable addition to engineering-based crafts.

1. An automated system and method of 3D point location wherein two (2) robotically steerable rays are made to intersect at a specified point in order to materialize it, comprising:
a) three (3) reference points defining known locations in a site coordinate system,
b) two (2) robotically-controlled ray-steering devices whose precise locations and rotational orientations in the site coordinate system are known apriori or obtained through the system and method of claim 2,
c) a controller device which directs the two ray-steering robotic devices of 1b) to steer their rays toward a common intersection point.

2. An automated system and method of device self-location and self-orientation in a 3D coordinate system superimposed upon a site or space, comprising:
a) three (3) reference points defining known locations in the site coordinate system,
b) a polar-coordinate angle-sensing device situated at unknown location and with unknown rotational attitude in the site coordinate system,
c) interaction between the device of 2b) and each reference point of 2a) through which said device obtains angular information signifying the direction toward said reference point in said device's local polar coordinate system (or direction vector equivalent),
d) a directional triangulation algorithm whereby the data of 2a) and 2c) are transformed to obtain the precise 3D location and rotational attitude in site coordinates of the device in 2b).

3. An embodiment whereby the robotically-steerable rays of claim 1 are pencil light beams.

4. An embodiment whereby the light beams of claim 3 are in the visible spectrum.

5. A pattern of visual feedback created by placing building materials in the vicinity of the visible beam intersection of claim 4, whereby two visible spots converge as the material is manipulated into position at the precise beam intersection.

6. In accordance with claim 1, downloading a CAD model or software-computed 3D pointlist into the controller of 1c) toward the objective of automatically materializing, under high-level human control, one among a plurality of locations preordained in a design.

7. In accordance with claim 1, a user-interface feature of 1c) whereby a worker selects from a list the next point to be automatically materialized.

8. In accordance with claim 1, the use of small spot retroreflectors to optically define the location of the reference points of 1a).

9. In accordance with claim 1, downloading into the controller of 1c) the known coordinate definitions of the reference points of 1a), and the automatic relaying of said reference point definitions from the controller of 1c) to each ray-steering device of 1b).

10. In accordance with claim 2, an embodiment of 2c) whereby the ray-steering device uses optical retroreflection and photodetection of a light beam, and readout from rotary encoders or equivalent, to sense the direction of a reference point.

11. In accordance with claim 2, an embodiment of 2d) whereby said directional triangulaton algorithm proceeds solving a tetrahedron, then solving location by distance trilateration, then solving attitudinal offset by rotational inference.

12. In accordance with claim 1, freely situating the two ray-steering devices positionally anywhere within the footprint of the triangle formed by the three reference points, the device not located precisely in the plane of the triangle, but rather situated near to the plane, for example, at the height of a tripod.

13. In accordance with claim 1, freely situating the two ray-steering devices without need for leveling or other rotational alignment to the site coordinate system axes.

14. In accordance with claim 1, materializing a prespecified point without iteratively finding the specified point by moving a receiver, but rather materializing said point a as a direct robotic response to a button press.

15. In accordance with claim 2, freely selecting the location of points to serve as the reference points of 2a), whereby said points spawn a triangle surrounding the spatial volume wherein device self-location is sought.

16. In accordance with claim 2, an embodiment where the polar-coordinate angle-sensing device of 2b) is a camera, a reference point of 2a) is any recognizable spatial point cast in the collected image, and the interaction of 2c) consists of image-processing to calculate the directional bearing of the ray to said point.

17. In accordance with claim 2, an embodiment where the polar-coordinate angle-sensing device of 2b) is a total station, theodolite, telescope, spacecraft or other observation platform.

18. In accordance with claim 1, an embodiment whereby ray intersection geometry is used in reverse for object location-sensing, motion tracking, or surface contouring, whereby two ray-steering devices are made to converge rays at the point of interest, and each said device reports the line equation of its ray to a common receiver, and whereby said receiver calculates the intersection of the two line equations to obtain the 3D coordinates of said point of interest.

19. In accordance with claim 6, purposefully selecting the next point to be physically materialized by means of interactive 3D model visualization graphics.

20. In accordance with claim 2, setting up a plurality of devices on the same reference pointset of 2a) as a means of achieving operability in a shared coordinate system, including acquisition of spatial data expressed in the same coordinate system.
